(19) United States
(12) Patent Application Publication
(10) Pub. No.: US 2018/0347643 A1
(43) Pub. Date: Dec. 6, 2018

(54) REVERSE INPUT BLOCKING CLUTCH

(71) Applicant: NTN CORPORATION, Osaka (JP)

(72) Inventor: Shoji ITOMI, Mie (JP)

(73) Assignee: NTN CORPORATION, Osaka (JP)

(21) Appl. No.: 15/761,669

(22) PCT Filed: Sep. 21, 2016
(86) PCT No.: PCT/JP2016/077808

§ 371 Date: Mar. 20, 2018

(30) Foreign Application Priority Data
Sep. 24, 2015 (JP) 2015-186891

(51) Int. Cl. F16D 41/066; F16D 15/00; F16D 41/08

(52) U.S. Cl. CPC F16D 41/066; F16D 41/088; F16D 15/00

(57) ABSTRACT

A locking-type reverse input blocking clutch includes an unlocking piece having unlocking portions for unlocking an output-side member. The portion of the unlocking piece other than the unlocking portions (i.e., its longitudinally central portion and intermediate portions) is inserted in a recess formed in an inner ring of the output-side member so as to open to the end surface of the inner ring to which torque is applied, and open to the outer periphery of the inner ring so that the entire unlocking piece is located axially within the output-side member. This clutch is thus small in axial dimension, and compact in entire size.

### TECHNICAL FIELD

This invention relates to a reverse input blocking clutch which transmits rotation of an input-side member to an output-side member when input torque is applied, and prevents rotation of the input-side member when reverse input torque is applied.

### BACKGROUND ART

Reverse input blocking clutches are configured to transmit rotation of the input-side member to the output-side member when input torque is applied to the input-side member, and to prevent rotation of the input-side member when reverse input torque is applied to the output-side member. Among such reverse input blocking clutches are “locking type” reverse input blocking clutches of which the output-side member is configured to lock up when reverse input torque is applied.

An exemplary locking type reverse input blocking clutch is shown in the below-identified Patent Document 1, and includes a torque transmission means disposed between an input-side member and an output-side member that rotate about a common center axis, and configured to transmit the rotation of the input-side member to the output-side member with a slight angular delay. A fixed member is disposed radially outwardly of the output-side member and has a cylindrical surface on the inner periphery thereof. The output-side member has a plurality of cam surfaces on the outer periphery thereof to define a wedge-shaped space which gradually narrows in the circumferential direction, between the inner peripheral cylindrical surface of the fixed member and each cam surface of the output-side member. A roller is mounted in each wedge-shaped space, and biased by a spring toward the narrower portion of the wedge-shaped space. A retainer is coupled to the input-side member so as to rotate together with the input-side member as an integral unit, and includes crossbars inserted in spaces opposite from the springs through the rollers.

With this reverse input blocking clutch, since the rollers are pushed into the narrower portions of the respective wedge-shaped spaces under the biasing force of the springs, when reverse input torque is applied to the output-side member, the rollers that are being biased by the springs in the anti-rotational direction engage the fixed member and the output-side member, thus locking the output-side member, so that the input-side member does not rotate.

When input torque is applied to the input-side member, the crossbars of the retainer, which rotates together with the input-side member as an integral unit, push the rollers that are being biased by the springs in the anti-rotation direction into the wider portions of the respective wedge-shaped spaces, against the biasing force of the springs, thereby disengaging these rollers from the fixed member and the output-side member. After the output-side member is thus unlocked, rotation is transmitted from the input-side member to the output-side member through the torque transmission means. (In this state, since the rollers that are being biased in the rotational direction by the springs move into the wider portions of the respective wedge-shaped spaces, they never engage the fixed member and the output-side member.)

### PRIOR ART DOCUMENT(S)

### Patent Document(s)

Patent Document 1: JP Patent 4806264

### SUMMARY OF THE INVENTION

### Object of the Invention

If it is desired to reduce the outer diameter of such a locking type reverse input blocking clutch, this can be done by e.g., reducing the diameters of the rollers, or reducing the number of rollers used, thereby reducing the pitch circle diameter (PCD). The arrangement disclosed in Patent Document 1, in which a plurality of rollers that abut each other are pushed by a single spring, also serves to reduce the pitch circle diameter and thus the outer diameter of the clutch, compared with a clutch of which every roller is directly pushed by a spring.

However, no effective means for reducing the axial dimension of such locking type reverse input blocking clutches are known, and this type of clutches are still not sufficiently compact in overall size.

It is especially difficult to reduce the axial dimension of the clutch disclosed in Patent Document 1, because the retainer for unlocking the output-side member by pushing the rollers into the wider portions of the respective wedge-shaped spaces includes a disk portion fixedly fitted to the outer periphery of the input-side member, and the plurality of crossbars for pushing the rollers axially extend from the peripheral edge of a disk portion so that the retainer has a crown shape as a whole with the disk portion disposed axially adjacent to the output-side member.

An object of the present invention is therefore to provide a locking type reverse input blocking clutch which is small in axial dimension, and compact in overall size.

### Means for Achieving the Object

In order to achieve this object, the present invention provides a reverse input blocking clutch comprising: an input-side member and an output-side member that are arranged to rotate about a common axis; a fixed member disposed radially outwardly of the output-side member; an unlocking piece coupled to the input-side member so as to rotate together with the input-side member as an integral unit; a torque transmission means disposed between the input-side member and the output-side member, and configured to transmit rotation of the input-side member to the output-side member with a slight angular delay; wherein the fixed member has a cylindrical surface on an inner periphery of the fixed member, and the output-side member has, on an outer periphery of the output-side member, a plurality of cam surfaces aligned with each other in a circumferential direction so as to define a wedge-shaped space that gradually narrows in the circumferential direction, between the cylindrical surface of the fixed member and each of the cam surfaces of the output-side member; rollers each received in a respective one of the wedge-shaped spaces; and elastic members configured to bias the rollers toward narrower portions of the respective wedge-shaped spaces; the unlocking pieces including unlocking portions each inserted in a space circumferentially opposed from one of the springs through either one or more than one of the rollers, wherein the output-side member has a recess which opens to an end surface of the output-side member to which torque is to be applied, and opens to an outer peripheral surface of the output-side member, and a portion of the unlocking piece other than the unlocking portions is received in the recess of the output-side member.

By inserting the portion of the unlocking piece other than the unlocking portions of the unlocking piece in a recess formed in the output-side member so as to open to the end surface of the output-side member to which torque is to be transmitted, and open to the outer periphery of the output-side member, the entire unlocking piece is arranged axially within the output-side member, so that the entire clutch is small in axial dimension.

In a preferred arrangement, the unlocking piece is coupled to the input-side member at a coupling portion of the unlocking piece adjacent to a radially central portion of the output-side member, the unlocking piece being arranged and configured such that, when the unlocking piece rotates together with the input-side member as an integral unit, intermediate portions of the unlocking piece between the coupling portion of the unlocking piece and the respective unlocking portions of the unlocking piece abut an inner wall of the recess of the output-side member.

In a further preferred arrangement, the unlocking piece is arranged and configured such that, when the unlocking piece rotates together with the input-side member as an integral unit, the intermediate portions of the unlocking piece comes into surface contact with the inner wall of the recess of the output-side member. With this arrangement, the contact surface pressure between the intermediate portions of the unlocking piece and the inner wall of the recess of the output-side member is small, so that damage to these members due to contact therebetween decreases.

### Advantages of the Invention

Since the portion of the unlocking piece other than the unlocking portions of the unlocking piece is inserted in a recess formed in the output-side member so as to open to the end surface of the output-side member to which torque is to be transmitted, and open to the outer periphery of the output-side member, the entire unlocking piece is arranged axially within the output-side member, so that the entire clutch is small in axial dimension.

### BRIEF DESCRIPTION OF THE DRAWINGS

FIG. 1 is an exploded perspective view of a reverse input blocking clutch of an embodiment.

FIG. 2 is a vertical sectional view of the reverse input blocking clutch of FIG. 1.

FIG. 3 is a sectional view taken along line of FIG. 2.

FIG. 4A is a sectional view corresponding to FIG. 3, showing an operational state of the reverse input blocking clutch.

FIG. 4B is a sectional view corresponding to FIG. 3, showing a different operational state of the reverse input blocking clutch.

### EMBODIMENT OF THE INVENTION

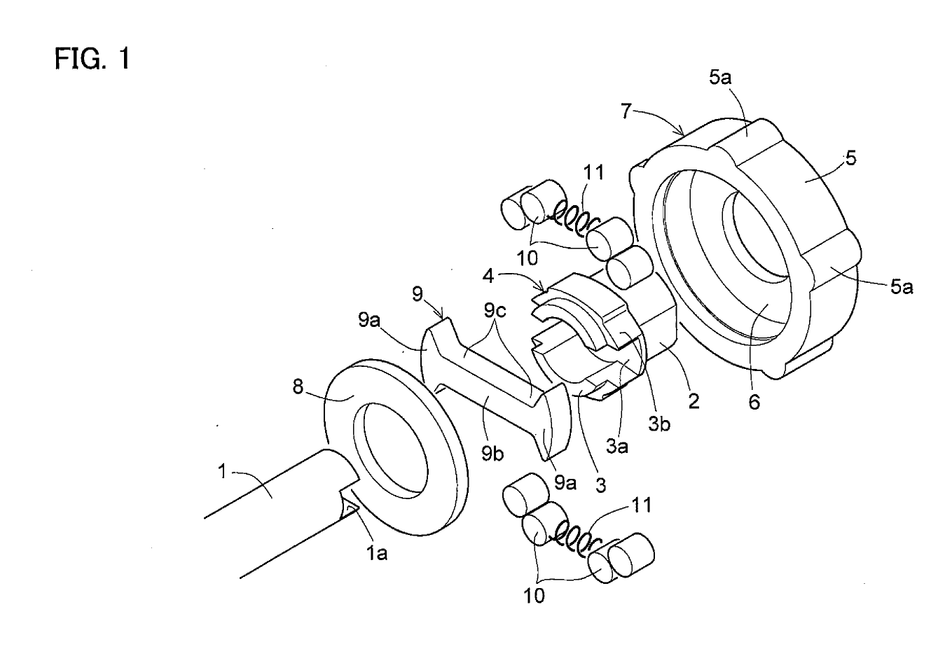

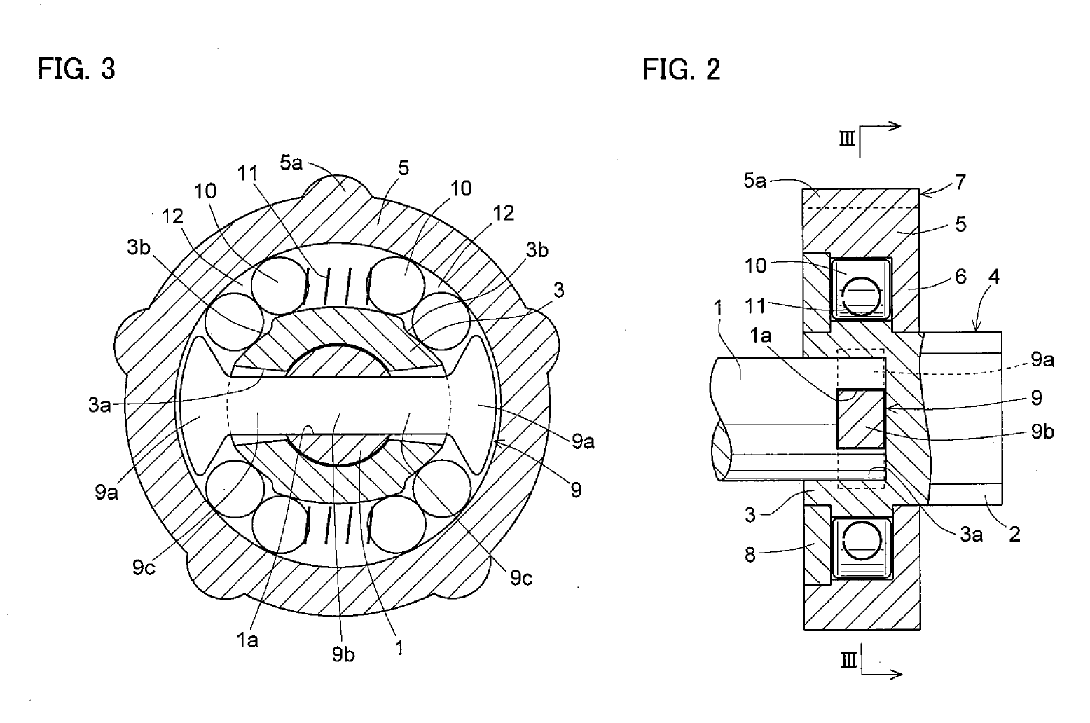

A reverse input blocking clutch embodying the present invention is now described with reference to the drawings. As shown in FIGS. 1-3, the reverse input blocking clutch comprises: an input shaft (input-side member) 1; an output-side member 4 comprising an output shaft 2 and an inner ring 3 that are integral with each other; a fixed member 7 comprising an outer ring 5 disposed radially outwardly of the inner ring 3, and a bearing member 6 disposed at one end of the outer ring 5 and integral with the outer ring 5; an oil-containing bearing 8 fitted to the inner periphery of the other end of the outer ring 5; a rod-shaped unlocking piece 9 having unlocking pieces 9 at the respective longitudinal ends thereof, the unlocking pieces 9 being disposed between the inner ring 3 and the outer ring 5; and rollers 10 and springs (elastic members) 11 disposed between the inner ring 3 and the outer ring 5. The elastic members 11 are compression coil springs.

The fixed member 7 has, on the outer periphery of the outer ring 5, a plurality of axially extending ribs 5a, and is configured to be fixed to a housing, not shown, by fitting the ribs 5a into axial grooves formed in the housing.

The input shaft 1 has a distal end (torque output end) formed with a diametric fitting groove 1a in which the longitudinally central portion 9b of the unlocking piece 9 is fitted so that input shaft 1 and the unlocking piece 9 are coupled together so as to rotate as an integral unit.

The inner ring 3 of the output-side member 4 has a recess 3a open at the distal end surface (torque input end surface) and the outer peripheral surface of the inner ring 3. The recess 3a includes circular hole portion at the diametrically central portion of the inner ring 3, and a pair of groove portions extending radially outward from the circular hole portion to form mirror images of each other. When the distal end portion of the input shaft 1 is slidably inserted into the circular hole portion of the recess 3a of the inner ring 3, with the portion of the unlocking piece 9 other than the unlocking portions 9a inserted in the recess 3a, the input shaft 1 and the output-side member 4 can be rotated about a common axis.

Each groove portion of the recess 3a of the inner ring 3 is shaped such that its width increases toward the outer periphery of the inner ring 3 with a constant spread angle. The portion of the unlocking piece 9 other than the unlocking portions 9a has a rectangular cross-section, and the intermediate portions 9c of the unlocking piece 9, i.e., its portions between the longitudinally central portion 9b (portion coupled to the input shaft 1) of the unlocking piece 9 and the unlocking portions 9a are inserted in the respective groove portions of the recess 3a of the inner ring 3 with predetermined gaps left therebetween in the rotational direction. Thus, when the input shaft 1 and the unlocking piece 9 are rotated as an integral unit, the intermediate portions 9c of the unlocking piece 9 are, with a slight angular delay, brought into surface contact with the inner walls of the respective groove portions of the recess 3a of the inner ring 3, so that, thereafter, the rotation of the input shaft 1 is transmitted to the inner ring 3 and the output shaft 2.

The inner ring 3 has an outer peripheral surface formed with a plurality of cam surfaces 3b that are circumferentially aligned with each other and radially opposed to a cylindrical inner peripheral surface of the outer ring 5 such that a wedge-shaped space 12 that gradually narrows in the circumferential direction is defined between each cam surface 3b and the cylindrical inner peripheral surface of the outer ring 5. The wedge-shaped spaces 12 comprises a plurality of circumferentially continuous pairs, each pair being defined, respectively, by cam surfaces 3b that are inclined in the same circumferential direction. Each roller 10 is received in a respective wedge-shaped space 12. Each spring 11 is received in a respective space through which the wider circumferential ends of two circumferentially adjacent wedge-shaped spaces 12 are opposed to each other, and biases the two rollers 10 on each side of the spring 11 in the direction in which the two rollers 10 are wedged into the narrower ends of the respective circumferentially continuous pair of wedge-shaped spaces 12, while abutting each other. Each unlocking portion 9a of the unlocking piece 9 is received in a respective space through which the narrower ends of two circumferentially adjacent wedge-shaped spaces 12 are opposed to each other, i.e., received in a space circumferentially opposite from one of the springs 11 through a circumferentially continuous pair of the wedge-shaped spaces 12.

The output-side member 4, which comprises the inner ring 3 and the output shaft 2, is supported, at its portions on the respective axial sides of the portion of the inner ring 3 where the cam surfaces 3b are formed, by the bearing portion 6 of the fixed member 7 and the oil-containing bearing 8, respectively. The output-side member may be supported by a support structure different from that of the embodiment, provided the support structure can keep the inner ring coaxial with outer ring of the fixed member. For example, the output-side member may be rotatably supported by oil-containing bearings fitted in the inner periphery of the outer ring at its respective ends.

With this reverse input blocking clutch, since each roller 10 is pushed into the narrow portion of the wedge-shaped space 12 under the biasing force of the corresponding spring 11, when reverse input torque is applied to the output shaft 2, the rollers 10 that are being pushed in the anti-rotational direction by the springs 11 engage the outer ring 5 of the fixed member 7 and the inner ring 3 of the output-side member 4, thus locking the output-side member 4 and preventing rotation of the input shaft 1.

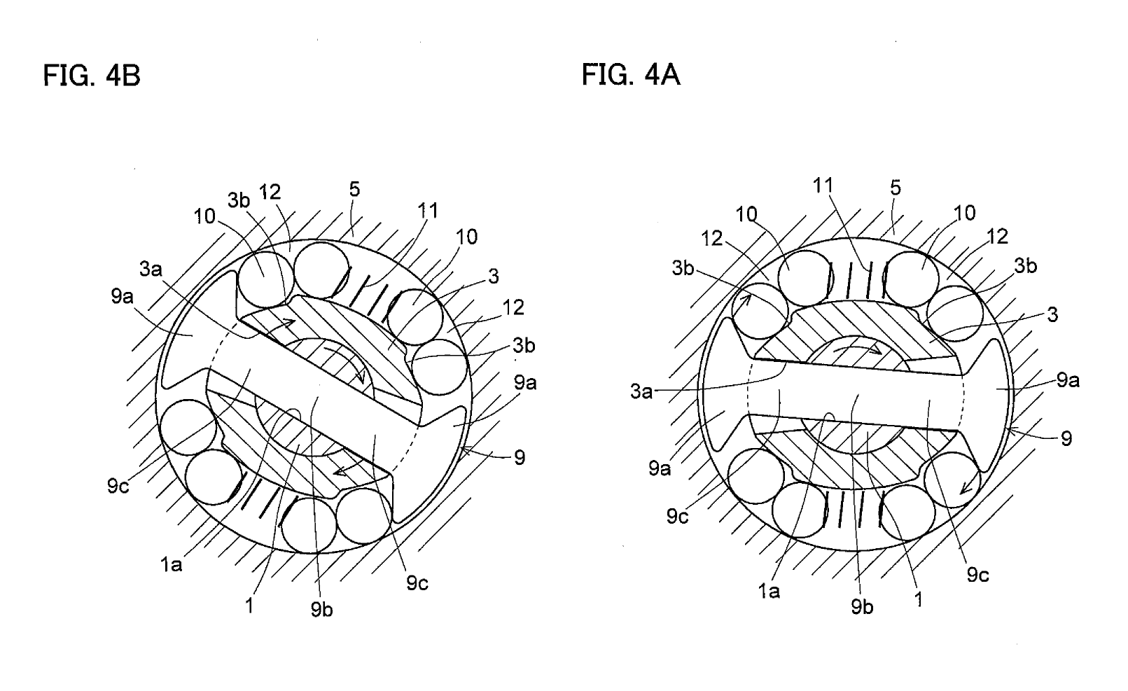

When input torque is applied to the input shaft 1, first, as shown in FIG. 4A, the unlocking portions 9a of the unlocking piece 9, which is configured to rotate together with the input shaft 1 as an integral unit, push the rollers 10 that are being biased in the anti-rotational direction by the springs 11 to the wider portions of the corresponding wedge-shaped spaces 12, against the biasing force of the springs 11, thus disengaging these rollers 10 from the outer ring 5 and the inner ring 3, and unlocking the output-side member 4. Then, when, as shown in FIG. 4B, the input shaft 1 further rotates and the intermediate portions 9c of the unlocking piece 9 comes into surface contact with the inner walls of the groove portions of the recess 3a of the inner ring 3, the rotation of the input shaft 1 is transmitted to the inner ring 3 and the output shaft 2. (In this state, since the rollers 10 that are being biased in the rotational direction by the springs 11 move into the wider portions of the respective wedge-shaped spaces 12, they never engage the outer ring 5 and the inner ring 3.)

Since the portions of the unlocking piece 9 other than the unlocking portions 9a, i.e., the longitudinally central portions 9b and the intermediate portions 9c are received in the recess 3a of the inner ring 3 so that the entire unlocking piece 9 is arranged axially within the output-side member 4, the clutch according to the present invention is small in axial dimension and compact in entire size, compared to a conventional clutch of which the output-side member is unlocked by the crown-shaped retainer.

The unlocking piece 9 is a simple shaped rod member, and can be formed without bending as was necessary in forming the conventional crown-shaped retainer. Thus, it can be manufactured easily and at a low cost by one of a larger number of manufacturing methods including pressing, forging, and metallic powder injection molding (MIM).

In the embodiment, in order to bring the intermediate, portions 9c of the unlocking piece 9 into surface contact with the inner walls of the groove portions of the recess 3a of the inner ring 3, the intermediate portions 9c of the unlocking piece 9 have rectangular cross-sections, while each groove portion of the recess 3a of the inner ring 3 is shaped such that its width increases toward the outer periphery of the inner ring 3 with a constant spread angle. Conversely, each groove portion of the recess of the inner ring may have a constant width, while the intermediate portions of the unlocking piece may be shaped such that their widths decrease toward the respective ends of the unlocking piece with predetermined angles. While the unlocking piece and the inner ring may be configured to be brought into line contact with each other, they are preferably brought into surface contact with each other in order to reduce the contact surface pressure, and thus the possibility of damage.

Needless to say, the present invention is applicable not only to a reverse input blocking clutch in which, as in the embodiment, a plurality of rollers abut each other, and are pressed by a single spring, but to a reverse input blocking clutch in which every roller is directly pushed by a spring.

### DESCRIPTION OF THE NUMERALS

1. Input shaft (input-side member)
1a. Fitting groove
2. Output shaft
3. Inner ring
3a. Recess
3b. Cam surface
4. Output-side member
5. Outer ring
6. Bearing portion
7. Fixed member
8. Oil-containing bearing
9. Unlocking piece
9a. Unlocking portion
9b. Longitudinally central portion
9c. Intermediate portion
10. Roller
11. Spring (elastic member)
12. Wedge-shaped space

1. A reverse input blocking clutch comprising:
an input-side member and an output-side member that are arranged to rotate about a common axis;
a fixed member disposed radially outwardly of the output-side member;
an unlocking piece coupled to the input-side member so as to rotate together with the input-side member as an integral unit;
a torque transmission means disposed between the input-side member and the output-side member, and configured to transmit rotation of the input-side member to the output-side member with a slight angular delay;
wherein the fixed member has a cylindrical surface on an inner periphery of the fixed member, and the output-side member has, on an outer periphery of the output-side member, a plurality of cam surfaces aligned with each other in a circumferential direction so as to define a wedge-shaped space that gradually narrows in the circumferential direction, between the cylindrical surface of the fixed member and each of the cam surfaces of the output-side member;
rollers each received in a respective one of the wedge-shaped spaces; and
elastic members configured to bias the rollers toward narrower portions of the respective wedge-shaped spaces;
the unlocking pieces including unlocking portions each inserted in a space circumferentially opposed from one of the springs through either one or more than one of the rollers,
wherein the output-side member has a recess which opens to an end surface of the output-side member to which torque is to be applied, and opens to an outer peripheral surface of the output-side member, and a portion of the unlocking piece other than the unlocking portions is received in the recess of the output-side member.

2. The reverse input blocking clutch of claim 1, wherein the unlocking piece is coupled to the input-side member at a coupling portion of the unlocking piece adjacent to a radially central portion of the output-side member, the unlocking piece being arranged and configured such that, when the unlocking piece rotates together with the input-side member as an integral unit, intermediate portions of the unlocking piece between the coupling portion of the unlocking piece and the respective unlocking portions of the unlocking piece abut an inner wall of the recess of the output-side member.

3. The reverse input blocking clutch of claim 2, wherein the unlocking piece is arranged and configured such that, when the unlocking piece rotates together with the input-side member as an integral unit, the intermediate portions of the unlocking piece comes into surface contact with the inner wall of the recess of the output-side member.
